(19) United States
(12) Patent Application Publication
(10) Pub. No.: US 2018/0320901 A1
(43) Pub. Date: Nov. 8, 2018

(54) Fan control system with charging controller for gas fireplace

(71) Applicant: Gerard R. Campeau, Newmarket (CA)

(72) Inventor: Gerard R. Campeau, Newmarket (CA)

(21) Appl. No.: 15/731,187

(22) Filed: May 2, 2017

(51) Int. Cl. F24B 1/185; H02J 7/00; H02M 3/04; H02P 27/08; H02K 7/14; H04M 1/725; H04W 4/14; H04L 12/28; F24B 1/191

(52) U.S. Cl. CPC F24B 1/185; H02J 7/0052; H02M 3/04; H02P 27/08; H02K 7/14; H04M 1/72533; H04L 2012/285; H04L 12/2816; H04L 12/2825; H04L 12/2898; F24B 1/191; H04L 2012/2841; H04W 4/14

(57) ABSTRACT

A Direct Current (D.C.) fan motor control system for an air cooled thermoelectric power generator. This electronic control system addresses the unique challenges that exist when thermoelectric generator (TEG) modules are used in a gas fireplace appliance to use D.C. fans as the primary air circulation element. Ideally, it is necessary to generate sufficient voltage for a fan motor while maximizing the efficiency of the overall system to permit the surplus energy generated above that required for the fan motor to be used to charge batteries, including a cellular phone handset battery. DC to DC switching converter techniques are used to manage the surplus energy available. A microcontroller based supervisor will monitor the TEG output voltage and determine when an electromechanical latching relay supplying power to the fan motor should be switched to the output of the DC to DC step down (buck) converter for maximum efficiency. The microcontroller also supervises a DC to DC step down converter assigned to charging a cellular phone by disabling the cellular handset charging function when the TEG output voltage is insufficient to maintain the fan and the cellular handset charger, thus prioritizing the fan motor function as the highest priority for the best reliability.

### FIELD OF THE INVENTION

The present invention relates to electronic control of fan motors for cooling of solid state Seebeck Effect thermoelectric modules when used in natural gas or propane fireplace insert appliances and hearth devices.

### BACKGROUND OF THE INVENTION

Wood fireplaces and stoves have been used for environmental heating and cooking for a very long time. A wood fireplace could be used with forced air convection for the purpose of further distributing the heat generated by the fire through a duct or plenum using fan blades coupled to an electric motor. A source of electrical energy is necessary to operate the fan motor. If the electrical energy is derived from alternating current (AC) associated with grid sources there does exist the potential for disruption of AC line voltage supply occasionally. Wood fireplaces are cumbersome to light and are not conducive to unattended operation, requiring periodic maintenance intervals by adding additional wood to sustain the fire.

An improvement to the forced convection wood burning fireplace is a natural gas enabled fireplace insert, which burns cleaner and supports unattended operation with constant gas flow. Forced air gas fireplaces with alternating current (AC) electric fan motors are presently in the stream of commerce for this purpose, and can be retrofitted to an existing masonry fireplace installation. Installing AC wiring and a wall mounted receptacle to provide power for the fan motor is not a trivial exercise and could be a significant financial consideration. A better solution that is more convenient during AC utility power disruptions would be to use a thermoelectric (TEG) module array to generate Direct Current (D.C.) voltage to power a self-contained D.C. fan motor. Seebeck effect thermoelectric modules exploit the property of heat transfer between properly arranged n-type and p-type semiconductors, to create the thermoelectric effect. A thermoelectric module will cause a potential energy EMF to be generated in the presence of a sustained heat differential offset across the module, between the hot and cold surfaces of the device. They are suited to the generation of D.C. electrical energy in situations where the waste heat resources associated with a combustion process exist.

There has been some research towards producing D.C. electrical energy using thermoelectric modules to power a D.C. fan motor for a natural gas fired appliance. Referring to U.S. Pat. No. 6,588,419 (Buezis, Kemp) there is described, a means to generate power for a D.C. fan motor whereby the physical mounting position of the motor to an internal duct allows the air flow from the fan to promote cooling of the cold side surface heat-sink fins of the thermoelectric generator (TEG) assembly thereby establishing a heat flux condition across the thermoelectric module. Further, it functions as a forced air blower to cause heat to flow from the combustion site to the ambient external room air through said duct, increasing the room temperature and thus the perceived comfort level. The specification acknowledges what can be referred to as a startup dynamics issue whereby there is the potential for thermal runaway with the cold side heat-sink warming before the voltage developed by the TEG is sufficient to start the fan motor. There was no specific suggestion to overcome that situation. The present invention establishes an enhanced control means to address the startup dynamics issue as expressed in this specification.

### SUMMARY

Some aspects of this disclosure may provide a system and a method to overcome some of the drawbacks of known techniques, and-or provide the public with a useful alternative.

It is an object of the present invention to provide a system and a method for controlling the D.C. fan motor used to establish convective air flow to remove heat from the cold side heat-sink fins of a thermoelectric generator module installed in a gas fireplace appliance. A thermoelectric module with a low delta temperature differential between the hot surface and the cold surface will begin at a low voltage difference proportional to the temperature difference. As the temperature rises at the combustion site due to the ignition of the gas, the hot surface of the thermoelectric generator will rise as that surface absorbs heat from the hot ignited gas. As the hot surface of the thermoelectric module increases relative to the cold surface, an increased temperature differential will be observed and thus an increased output voltage. The voltage output of the thermoelectric device is coupled electrically to an input power port configured to receive the electrical energy from the thermoelectric device and apply it to the fan motor.

Fan motors are designed to operate optimally with a specific rated operating voltage. The fan motor manufacturer may offer a variety of useable operating voltages to accommodate the voltage of the electrical energy resource available. This allows the system designer to match the output voltage of the thermoelectric array to the closest available rated voltage of the selected fan motor. The fan motor specification will typically indicate the start voltage at which the increasing rotor magnetic field strength will begin to interact with the magnetic field of the stator magnets to overcome the inertial mass of the fan rotor assembly, and initiate the rotation of the fan motor. Operating the fan motor at a voltage higher than the rated voltage is not recommended if the specification for air flow through the duct is sufficient to maintain the desired output voltage from the thermoelectric module. A fan motor specified at 12 Volts D.C. for example, should be limited to 12 Volts for maximum service life.

The present invention provides a means to control a D.C. fan motor to provide an optimum startup voltage phase whereby initially, the electrical output from the TEG is connected directly to the fan motor through an electromechanical switch implemented as a latching relay. The output voltage from the TEG will increase as the temperature reaching the hot side of the TEG from the combustion site also increases. The cold side of the TEG is coupled to a large finned heat sink which dissipates the heat flux through the TEG from the hot side surface of the TEG. The hot side surface of the TEG absorbs heat very rapidly from the combustion site, since the hot side surface is intimately coupled to a physically large metal interface surface that is in direct proximity to the heat flow from the gas flame. The output voltage of the TEG rises proportionally with the delta temperature or difference temperature (delta temperature) across the hot and cold surfaces of the TEG. When the D.C. output voltage of the TEG rises sufficiently to provide an adequate startup voltage for the fan, it will begin to rotate thereby causing air flow to develop in the duct. As a consequence the air flow will pass through the fins of the cold surface heat sink and provide a convective flow enhancing the rate at which the heat radiated from the fins is removed to ambient. As the cold surface temperature of the TEG decreases in response to the increasing air flow, a positive feedback loop is formed whereby the increasing delta temperature causes an increased output voltage. When the voltage applied to the fan motor reaches the rated voltage for the fan motor, the control system prevents any further increase, because the voltage applied to the motor is monitored and electronically limited to the rated voltage.

A microcontroller based control system is provided whereby the voltage to the fan motor is switched by an electromechanical relay to drive the motor from a DC - DC switching converter, referred to as a buck or step down converter. The air flow at this point will be highest at the rated voltage of the fan for maximum air flow. To further reduce the current required by the fan, the controller used a pulsed output voltage technique similar to PWM which leverages the inertial mass and thus the stored kinetic energy of the rotor assembly to achieve up to 10% lower average current requirements depending upon the weight of the rotor and the quality of the support bearing assembly which affects the coefficient of friction and ease of rotation.

### BRIEF DESCRIPTION OF THE FIGURES

An illustrative embodiment of the present invention is described by way of example only, with reference to the appended drawing figures, wherein:

FIG. 1 is a diagram of one embodiment of a fan motor control system of the present invention;

### DETAILED DESCRIPTION

It should be understood that the present invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “includes”, “including,” “comprising,” or “having” and variations thereof herein is meant to encompass the items listed thereafter and equivalents thereof as well as additional items. Unless limited otherwise, the terms “connected,” “coupled,” “configured” and “mounted” and variations thereof herein are used broadly and encompass direct and indirect connections, couplings and mountings. In addition, the terms “connected” and “coupled” and variations thereof are not restricted to physical, mechanical or electrical connections or couplings. Furthermore, and as described in subsequent paragraphs, the specific mechanical and/or other configurations illustrated in the drawings are intended to exemplify embodiments of the invention. However, other alternative mechanical and/or electrical and other configurations are possible which are considered to be within the teachings of the disclosure.

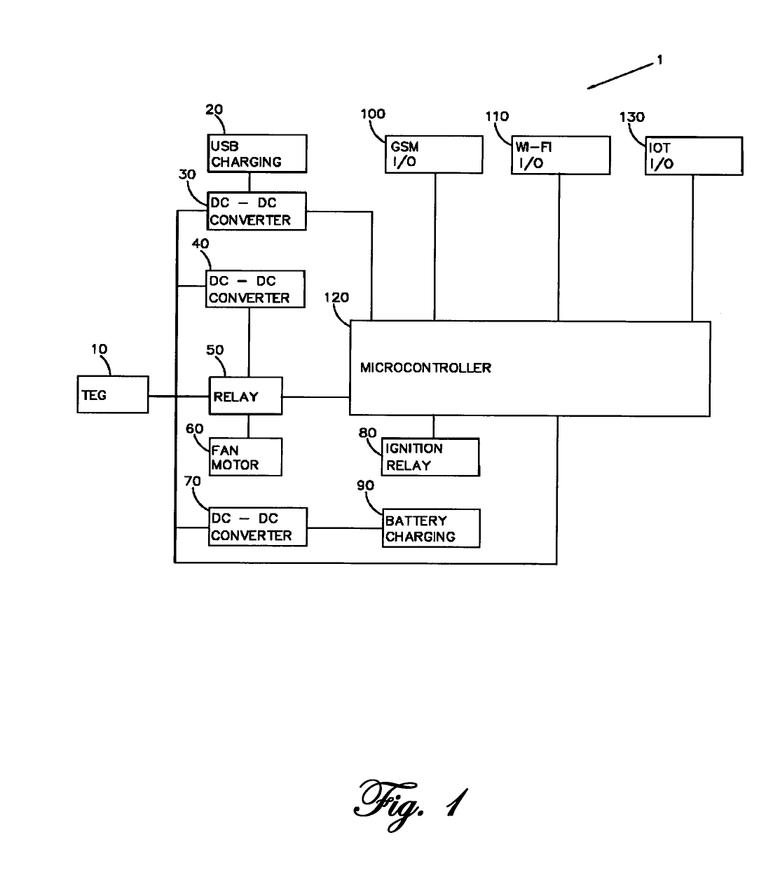

FIG. 1 shows one embodiment of a thermoelectric power generation control system in accordance with the teachings of the present invention. The electrical output of thermoelectric generator module array (TEG) 10 is coupled to the system controller apparatus to provide a voltage sufficient to cause fan motor 60 to operate at the maximum rated voltage for the fan motor when the output voltage of TEG 10 has reached a state of equilibrium whereby the maximum heat flux has been established. At startup when the gas has been ignited and the delta temperature is zero, the output voltage from the TEG 10 will be zero volts. As the temperature rises and the delta temperature increases, the Direct Current (D.C.) output voltage from the TEG 10 will increase in proportion to the delta temperature across the hot and cold sides of the TEG.

The output from the TEG 10 is connected to microcontroller 120 through a suitable conditioning and regulation device of 3.3 Volts D.C., to provide power to the microcontroller 120 and as the output voltage from the TEG 10 passes 3.3 Volts D.C., the microcontroller 120 begins operating and executing the user program. The microcontroller monitors the voltage from the TEG 10 with an integral Analog to Digital Converter inside the microcontroller 120 and when the output voltage from the TEG 10 reaches 5 Volts D.C., the stored microcontroller program pulses the SET coil of latching Relay 50 for 200 milliseconds. The connection circuit from the output of Relay 50 is connected to Fan Motor 60 in such a way that the voltage to the fan is routed from either of two sources through the relay. One such path is through the relay contacts joining the output from the TEG 10 directly to the motor. The second path is through the relay contacts joining the output of DC-DC converter 40 to the motor.

DC-DC converter 40 is a step-down switching regulator with a fixed output voltage of 12 Volts D.C., which is the rated voltage of Fan Motor 60. Switching DC-DC step down converters are considered to be very efficient due to the way they regulate the output voltage without consuming more energy from the source voltage than is required to maintain output regulation. Analog regulators by contrast are required to dissipate the voltage differential between input and output as excess heat thus a switching regulator is preferred. DC-DC converter 40 is responsive to a control signal from microcontroller 120 allowing the output voltage to be pulsed on and off periodically for 50 to 75 milliseconds every 333.3 milliseconds. This reduces the average current supplied to the fan while exploiting the kinetic energy stored in the rotating rotor assembly when the output from the TEG supports this operation.

Fan motor 60 will begin to operate at approximately 50% of the maximum rated voltage applied. For the particular fan used, the rated voltage is 12 Volts D.C., thus the fan will begin rotating when the TEG 10 reaches approximately 6 Volts D.C. and Relay 50 is configured to route the TEG 10 output voltage directly to the fan motor 60 to ensure that the motor receives an energizing voltage directly from the TEG 10 while the output voltage from the TEG 10 is below 12 Volts D.C., which is the maximum rated voltage of the fan motor. This will cause the fan motor to supply air flow as quickly as possible by following the rising output voltage from the TEG 10 as it is directly applied to the fan motor.

The Microcontroller 120 monitors the output voltage from the TEG 10 as it rises and when the output voltage reaches 12 Volts D.C., the fan motor has reached its rated voltage. The output voltage from the TEG 10 will continue to increase beyond 12V as the temperature increases proportionally, and the controller will supply energizing pulses to the fan motor at periodic intervals.

The quantity and arrangement of the TEG 10 devices is such that the output voltage from the TEG 10 array is predicted to be greater than the output of the maximum rated voltage of the fan motor. This ensures that additional surplus energy is available for battery charging or other purposes. Since the fan motor 60 rated voltage is 12 Volts D.C., there is provided a means to limit the fan motor voltage to a maximum of 12 Volts D.C. through DC-DC converter 40 which is a switching step-down regulator. Microcontroller 120 pulses the RESET coil of latching Relay 50 for 200 milliseconds, which reconfigures the interconnection of the TEG 10 output so that the Fan motor 60 receives its energizing voltage from DC-DC converter 40 at an output voltage of 12 Volts D.C., which fixes the fan motor voltage at 12 Volts D.C. with energizing pulses.

The output voltage of the TEG 10 array is typically higher than the fan motor rated voltage of 12 Volts D.C. This arrangement supports the generation of an energy surplus that can be directed to other circuit functions, including Battery Charging 90 through DC-DC converter 70 which is configured to float charge a 12 Volt D.C. battery at a fixed voltage of 13.8 Volts D.C.

Another battery charging function includes USB Charging 20 cell phone charging port through DC-DC converter 30 which is a fixed output voltage charging port at 5 Volts D.C. through a standard type A USB connector with a compatible cable to a cell phone. During utility power disruptions when AC line voltage is unavailable, there is provided a mean to charge a cell phone from this circuit, as well as the ability to charge a 12 Volt D.C. battery through Battery Charging port 90.

Microcontroller 120 monitors the output voltage of the TEG 10 array in order to ensure that enough surplus energy exists to maintain the fan motor voltage and charge a cell phone simultaneously. There may however be circumstances when that surplus energy drops below a threshold that is sufficient to maintain the air flow from the fans while charging a cell phone battery. If the gas flow is restricted for example to reduce the ambient temperature in the room where it is perceived to be too warm, then the output voltage will be reduced. Microcontroller 120 will disable the cell phone charging port during that time to maintain the fan motor voltage as a priority. When the voltage is again increased from the TEG 10 by increasing the gas flow creating a hotter combustion site, microcontroller 120 will enable the cell phone charging port. Without this feature, the current drawn by both the fan motor and the USB Charging 20 port at reduced temperatures would cause the fan motor to stall which will eventually result in thermal runaway as a result of undesired warming of the cold side surface of the TEG 10 resource.

There is provided a means to allow the system controller to be responsive to both GSM cellular communications, and industry standard Wi-Fi networking support with an Ethernet routing switcher as part of the managed resources of the controller. On-board microcontroller 120 firmware supports external monitoring functions by allowing a cellular phone handset with SMS text messaging to receive status messages regarding the condition of the environment such as the TEG 10 output voltage, temperature and any other parameter considered useful to monitor. GSM Input/output (I/O) 100 is a hardware resource configured to facilitate this function. Further, the user may choose to send an SMS text message to the GSM I/O 100 hardware to remotely activate Ignition Relay 80 thus causing the gas appliance to operate. The GSM I/O 100 hardware is configured to at least optionally transmit periodic temperature and voltage readings to the user cell phone thus confirming operation of the appliance if the user desires.

There is provided a means to allow the system controller to support Internet of Things (IOT) networking with a wireless hardware radio as part of the managed resources of the controller. On-board microcontroller 120 firmware is responsive to messages received by the IOT Input/output (I/O) 130 hardware node, to remotely activate Ignition Relay 80 thus causing the gas appliance to ignite the burner. The IOT I/O 130 hardware is responsive to a signal from microcontroller 120 to at least optionally transmit periodic temperature and voltage readings to another node in the network, thus confirming operation of the appliance if the user desires.

Wi-Fi switching router WI-FI Input/output (I/O) 110 is present to provide internet routing and switching functions in the event of a power disruption to continue to provide internet access. If the Internet Service Provider (ISP) is capable of maintaining Internet communications to the entry point of demarcation of the residence, then Battery Charger 90 can maintain the charge on the battery, which serves as the power supply to the Internet Modem device, thereby allowing the continuation of Internet communications in conjunction with WI-FI I/O 110 which also uses the power supplied by the TEG 10 resource, independent of the status of external line voltage conditions for convention AC distribution.

While the invention has been described with reference to specific embodiments, modifications and variations of the invention may be constructed without departing from the scope of the invention, which is defined in the following claims.

1. A system and method for managing and controlling a Direct Current (D.C.) fan motor providing cold side air convection with thermoelectric generator (TEG) arrays for hearth devices providing a combustion site, comprising:
a) a printed circuit board with a microcontroller to direct the sequence and operation of the circuit elements contained therein;
b) an electromechanical latching relay, responsive to operation by said microcontroller coupled to at least one D.C. fan motor;
c) at least one wireless communications means for SMS text message control, responsive to said microcontroller;
d) at least one electromechanical ignition relay means responsive to operation by said microcontroller;
e) at least one charging means to connect to any compatible cellular phone handset with a suitable charging port;
f) at least one standard Wi-Fi switching router apparatus;
g) at least one battery charging means to support the connection and charging of any compatible battery of any electrochemical construction;
h) a plurality of electronic DC to DC step down switching converters with at least one DC to DC converter for each fan motor, at least one DC to DC converter for the cellular handset charging port, and at least one DC to DC converter for external battery charging;

2. A system and method as defined in claim 1 wherein said fan motor receives an electrical energizing voltage through a first contact of said electromechanical latching relay, responsive to a first signal from said microcontroller which monitors the output voltage from the thermoelectric generator (TEG), using an integral Analog to Digital conversion means as part of said microcontroller, causing the fan motor to receive the energizing voltage directly from the TEG when the output voltage is less than the rated voltage of said fan motor, further causing the fan motor to receive the energizing voltage from the output of a DC to DC step-down switching converter through a second contact of said electromechanical latching relay in response to a second signal from said microcontroller when the output voltage from the TEG is at or above the rated voltage for the fan motor, thereby allowing said fan motor to operate at the rated voltage specified by the manufacturer of said fan motor, through said DC to DC step-down switching converter, establishing the appropriate conditions for an energy surplus to be achieved in proportion to the potential difference between the maximum TEG 10 voltage and the rated voltage of the fan motor.

3. A system and method as defined in clam 1 wherein said communication means for a preferred embodiment of this controller is implemented using the Global System for Mobile (GSM) communications protocol standard compatible with cellular telephone handset devices, responsive to control and operation signals from said microcontroller, capable of monitoring voltage and temperature conditions and reporting the data by means of Short Message Service (SMS) text message transmissions to and from the cellular handset means.

4. A system and method as defined in clam 1 wherein said communication means is implemented using the Code Division Multiple Access (CDMA) communications protocol standard compatible with cellular telephone handset devices, responsive to control and operation signals from said microcontroller, capable of monitoring voltage and temperature conditions and reporting the data by means of Short Message Service (SMS) text message transmissions to and from the cellular handset means.

5. A system and method as defined in clam 1 wherein the cellular charging means is implemented using a DC to DC step-down switching converter means with at least a fixed 5 Volt D.C. output, capable of facilitating a connection means using a suitable cable for charging the cellular handset, responsive to a signal from said microcontroller monitoring the TEG output voltage to enable or disable the 5 Volt charging potential energy output, said microcontroller using an integral Analog to Digital conversion means to measure the TEG output voltage to determine the threshold voltage at which said microcontroller enables or disables the charging means.

6. A system and method as defined in clam 5 wherein the cellular charging means is implemented using a DC to DC step-down switching converter means with at least a fixed 5 Volt D.C. output, with at least one battery of any electrochemical construction to absorb short term variations in the output of the 5V D.C. output while charging said battery.

7. A system and method as defined in clam 5 wherein the cellular charging means is implemented using a DC to DC step-down switching converter means with at least a fixed 5 Volt D.C. output, with at least one battery of any electrochemical construction to absorb short term variations in the output of the 5V D.C. output while charging said battery, and including a double layer super capacitor array whereby said super capacitor array is used to allow said battery to be connected by an isolation means such that said battery is isolated from the charging circuit, thereby allowing said battery to be charged while it is isolated from said super capacitor array, responsive to a signal from said microcontroller which controls the period and duration of the isolation means.

8. A system and method as defined in clam 1 wherein the battery charging means is implemented using a DC to DC step-down switching converter with a at least a fixed 13.8 Volt D.C. output, capable of charging at least a 12 Volt battery.

9. A system and method as defined in clam 1 wherein said ignition relay means is responsive to a signal from said microcontroller, which is further responsive through firmware to an SMS text message through said communication means requesting that said ignition relay contacts should be closed for a minimum time duration deemed sufficient to cause the gas to be ignited.

10. A system and method as defined in clam 1 wherein said communications means is optionally implemented as a wireless network communications node, specifically referred to as an Internet Of Things (IOT) node, responsive to a signal from said microcontroller, which is further responsive through firmware in receipt of a message from another node within range through said communication means requesting that said ignition relay contacts should be closed for a minimum time duration deemed sufficient to cause the gas to be ignited.
